(19) United States
(12) Patent Application Publication
(10) Pub. No.: US 2013/0164580 A1
(43) Pub. Date: Jun. 27, 2013

(54) PORTABLE STORAGE BATTERY FOR ELECTRIC VEHICLES AND USING METHOD THEREOF

(71) Applicant: Sanwa AU, Dongguan (CN)

(72) Inventor: Sanwa AU, Dongguan (CN)

(21) Appl. No.: 13/723,394

(22) Filed: Dec. 21, 2012

(30) Foreign Application Priority Data
Dec. 26, 2011 (CN) 201110441309.0

(51) Int. Cl. H01M 2/10; H02J 7/00

(52) U.S. Cl. CPC H01M 2/1077; H01M 2/1005; H02J 7/0042
USPC 429/83; 429/96; 429/99; 320/137

(57) ABSTRACT

The invention discloses a portable storage battery for electric vehicles and a using method thereof. The portable storage battery includes storage battery units that include a storage battery casing, a storage battery cell is arranged in the storage battery casing, a socket is arranged at the end of the storage battery casing, and the socket is provided with a power plug. According to the invention, voltage required to drive one vehicle is in a manner of decentralization decomposed layer by layer, which brings convenience to both dismounting and mounting of the storage battery. The storage battery units are put in storage battery boxes in electric vehicles and connected with each other in series for use; in a case of out of power, the storage battery units are pulled out and then put into a charging cabinet to be connected with the charging cabinet through the socket to be charged.

### TECHNICAL FIELD OF THE INVENTION

The invention relates to the technical field of electric vehicle accessories and mounting ways thereof, in particular to a portable storage battery for electric vehicles and a using method thereof.

### BACKGROUND OF THE INVENTION

Electric vehicles are vehicles that are powered by on-board power supplies, driven to run by motors and are in accordance with various requirements of road traffic regulations and safety regulations. Due to less influence on environment with respect to traditional cars, electric vehicles are considered to have good prospect, and the relevant techniques have been matured. Batteries are major energy parts of electric vehicles, lead-acid storage batteries, nickel cadmium storage batteries, nickel-hydrogen storage batteries or lithium batteries in various kinds are generally used in various electric vehicles in the prior art. As there are many kinds of storage batteries and also many voltage standards, simultaneously, as storage battery groups in a fixed structure that are difficult to be replaced and maintained are used in electric vehicles at delivery, by once charging, after running certain kilometers, electric vehicles have to be charged again for six to eight hours in stations or at home to run again, this greatly restricts the popularization and spreading of environmentally friendly electric vehicles. In addition, as storage battery groups for electric vehicles are too heavy, usually, hundreds of kilograms to thousands of kilograms, manual replacement of a plurality of storage batteries or a plurality of storage battery drawers is both time and labor wasted; furthermore, the power wires need to be reconnected one by one, which is quite inconvenient; it is even impossible for manual replacement to move the storage battery groups in a whole.

Chinese Patent Document No. 200820110130.0 “Storage batter group for multi-motor electric vehicles” disclosed a storage battery group for multi-motor electric vehicles, including a plurality of storage batteries that are independent from each other, and each one of motors is powered by one storage battery separately. In the storage battery group in such structure, it is necessary to provide one motor for each one of the storage batteries. As a result, the whole storage battery group looks very cumbersome, and the weight of the whole electric vehicle is increased. Furthermore, due to complexly internal power wire arrangement, inconvenient maintenance and high cost, it is disadvantageous for production and popularization.

### SUMMARY OF THE INVENTION

The purpose of the invention is to provide a portable storage battery for electric vehicles and a using method in allusion to technical problems to be solved. In a manner of decentralization, the portable storage battery and the using method bring convenience to both dismounting and mounting of the storage batteries.

To solve the technical problems, the invention employs the following technical solutions.

A portable storage battery for electric vehicles includes storage battery units that include a storage battery casing, a storage battery cell is arranged in the storage battery casing and a socket is arranged at the end of the storage battery casing.

Specifically, the storage battery units have a voltage of 36V.

Specifically, the storage battery cell consists of a plurality of cylindrical storage batteries connected in series and/or in parallel.

Specifically, a storage battery cover is arranged above the storage battery casing and articulated with the storage battery casing.

Specifically, the storage battery casing is provided with a handle.

Specifically, the storage battery casing is provided with a protective valve for protecting the socket.

Specifically, the socket is also provided with a power plug.

Specifically, the power plug is provided with an air inlet and an air outlet, which are communicated with the interior of the storage battery casing, respectively.

Specifically, the power plug is provided with an information transfer joint.

Specifically, the power plug is sleeved with a water-proof sealing ring.

A method for using the portable storage battery for electric vehicles includes steps as follows: putting the required number of storage battery units in storage battery boxes in electric vehicles and connecting the storage battery units in series for use; in a case that the storage battery units are out of power, the storage battery units are pulled out, respectively, and then put into a charging cabinet to be connected with the charging cabinet through the socket so as to be charged.

Specifically, the storage battery units that are put into the charging cabinet are charged at the power off-peak period.

The invention has advantages as follows.

The portable storage battery for electric vehicles provided in the invention includes storage battery units that include a storage battery casing, a storage battery cell is arranged in the storage battery casing, a socket is arranged at the end of the storage battery casing, and the socket is provided with a power plug. According to the invention, voltage required to drive one vehicle is in a manner of decentralization decomposed layer by layer, which brings convenience to both dismounting and mounting of the storage battery. The storage battery units in the invention are about ten kilograms heavy, the storage batteries may be replaced for electric vehicles manually, and the time for replacement only needs three minutes, therefore the trouble of long-time charging of electric vehicles is avoided. The storage battery casing is provided with a socket through which the storage batteries can be connected with an external charging device for charging, it is convenient and fast.

The method for using the portable storage battery for electric vehicles in the invention includes steps as follows: putting the storage battery units in storage battery boxes in electric vehicles, connecting the storage battery units in series and then electrically connecting them with a distribution box that supplies power to the motors of vehicles; in a case of out of power, the storage battery units are pulled out and then put into a charging cabinet to be connected with the charging cabinet through the socket so as to be charged. By the method for using the portable storage battery in the invention, the storage batteries may be connected into or separated from the storage battery boxes quickly, the traditionally cumbersome charging mode for electric vehicles is changed into a portable battery-replacing mode, the user is unlikely to worry about looking for a charging station at any moment, and both time and travel of the user are not delayed.

### BRIEF DESCRIPTION OF THE DRAWINGS

FIG. 1 is a partially exploded view of a storage battery unit;

FIG. 2 is a structural diagram of mounting of the storage battery unit in an electric vehicle;

FIG. 3 is another structural diagram of mounting of the storage battery unit in the electric vehicle; and

FIG. 4 is a structural diagram of a charging cabinet.

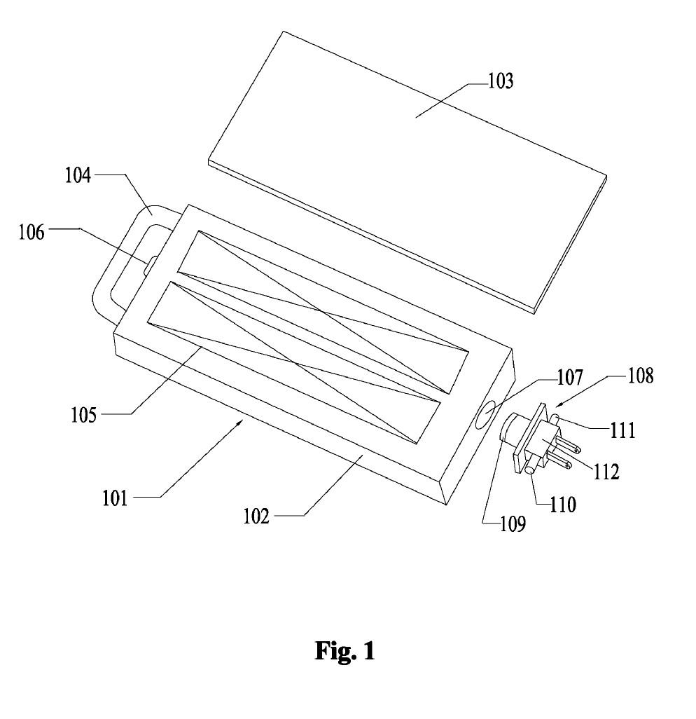

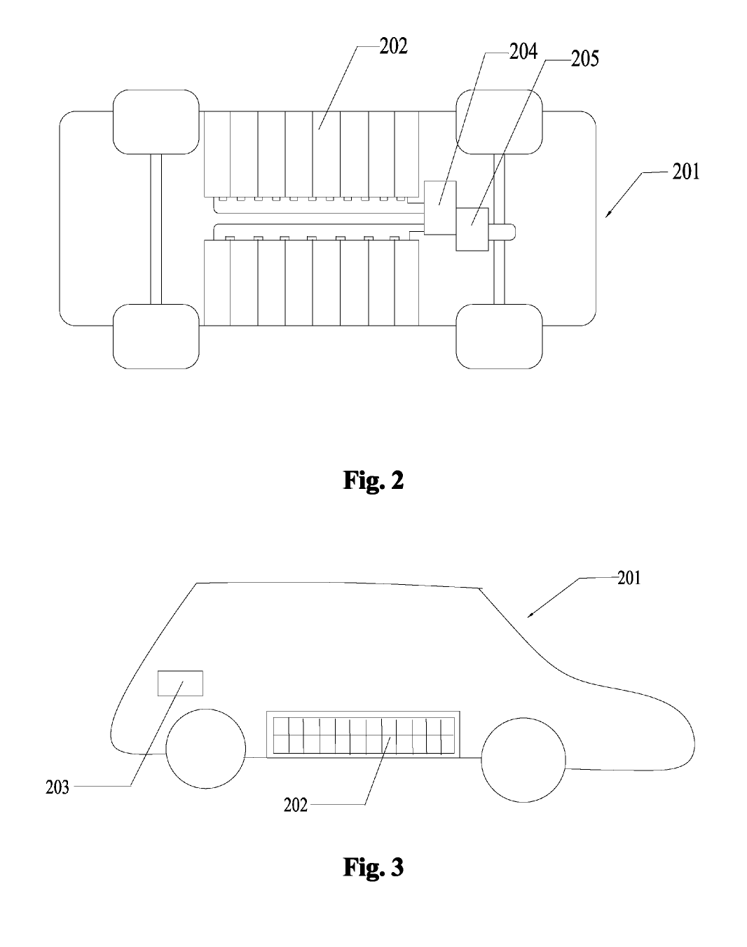

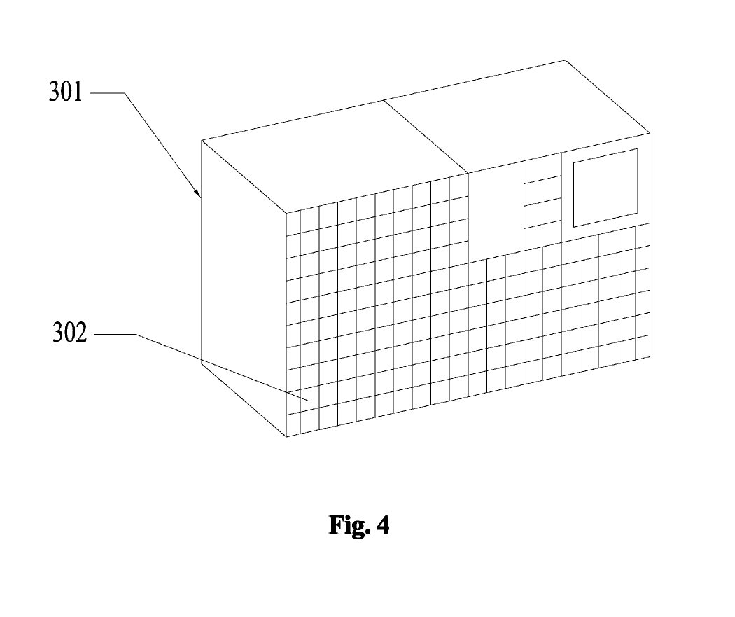

### DETAILED DESCRIPTION OF THE INVENTION

A portable storage battery for an electric vehicle 201 includes storage battery units 101 that include a storage battery casing 102, a storage battery cell 105 is arranged in the storage battery casing 102, a socket 107 is arranged at the end of the storage battery casing 102, and the storage batteries may be connected with an external charging device through the socket 107, therefore it is convenient and fast. According to the portable storage battery in the invention, voltage required to drive one electric vehicle 201 is in a manner of decentralization decomposed layer by layer, and a plurality of storage battery units 101 are connected in series to reach the voltage required by the electric vehicle 201, thus bringing convenience to both dismounting and mounting of the storage batteries. The storage battery units in the invention are about ten kilograms heavy, the storage batteries may be replaced for the electric vehicle 201 manually, and the time for replacement only needs three minutes, therefore the trouble of long-time charging of the electric vehicle 201 is avoided. According to the portable storage battery in the invention, the conventionally cumbersome shape of the storage batteries for the electric vehicle 201 is changed, the replacement of all storage batteries may be finished by the user within several minutes, and the replacement may be completed by only one person, so labor is saved. In an assembled structure, the portable storage battery in the invention may be suitable for electric vehicles 201 of any kind, and also may be updated with the development of the battery technique, which can facilitate the development of electric vehicles 201 effectively.

Specifically, the storage battery units 101 have a voltage of 36V that is a safe voltage. The storage battery units 101 may be directly charged, meeting the principle of safe and fast operation.

Specifically, the storage battery cell 105 consists of a plurality of cylindrical storage batteries connected in series and/or in parallel.

The storage battery casing 102 is provided with an indicator 106 that may be used for displaying both the charging situation of the storage batteries and the internal resistance situation. When there is any damage in the storage battery cell 105, the internal resistance of the storage battery units 101 changes, this will be displayed through the indicator 106, now new storage battery units 101 may be used onto the electric vehicle 201 to ensure the normal use of the electric vehicle 201.

Further, in the invention, a storage battery cover 103 is arranged above the storage battery casing 102 and articulated with the storage battery casing 102, and the storage battery cover 103 may prevent dust or impurities from entering into the cavity in order to keep the storage battery units 101 clean. The maintenance is convenient, and it just needs to open the storage battery cover 103 to carry out maintenance when maintenance is required. Repeated usage is available; it just needs to open the storage battery cover 103 to replace the storage battery cell 105 when it is necessary to replace the storage batteries. The storage battery casing 102 may be still used, which is environmentally friendly and economic.

In the invention, the storage battery casing 102 is provided with a handle 104, by which it is convenient to lift the storage battery units 101 that are about ten kilograms and also convenient for replacement, transport, charging, storage and maintenance of the storage battery units 101.

Specifically, the storage battery casing 102 is provided with a protective valve (not shown) for protecting the socket 107, in order to prevent other objects from damaging the socket 107 of the storage battery units 101.

Specifically, the socket 107 is also provided with a power plug 108 by which the storage battery units 101 are connected to the storage battery boxes 202.

Specifically, the power plug 108 is provided with an air inlet 110 and an air outlet 111, which are communicated with the interior of the storage battery casing 102, respectively. As the storage batteries will produce high temperature when in use, by arranging the air inlet 110 and the air outlet 111 on the power plug 108, gas flowing may be formed, heat is carried away when gas flows, so that the heat dissipation problem during the working of the storage batteries is solved effectively.

Specifically, the power plug 108 is provided with an information transfer joint 112, the information transfer joint 112 is electrically connected with the power plug 108, the information transfer joint 112 may be connected with a computer in the electric vehicle 201 to reflect relevant information such as the electricity quantity of the battery to the electric vehicle 201 user via the computer in time.

Specifically, the power plug 108 is sleeved with a water-proof sealing ring 109. The water-proof sealing ring 109 may make the power plug 108 and the socket 107 join tightly, in order to prevent moisture, dust and the like from entering into the interior of the storage battery units 101.

In the invention, the portable storage battery is equipped with a dedicated charging cabinet 301, the charging cabinet 301 is provided with a plurality of separated charging lattices 302, the storage battery units 101 are connected with the plug structure of the charging lattices 302 via the plug 107, quick connection or separation may be achieved, and the replacement is convenient. The replaced storage battery units 101 may be charged at the power off-peak period, in order to get out of the peak hours of power consumption.

The method for using the portable storage battery in the electric vehicle 201 in the invention is as follows: when the electric vehicle 201 is used, the storage battery units 101 are put into the storage battery boxes 202 in the electric vehicle 201, two to twelve groups of storage battery boxes 202 are designed according to the requirement of the vehicle on power, with two to four groups for tiny cars, four to eight groups for common cars, eight to twelve groups or even more for trucks or buses. Each one of the storage battery units 101 is put into one group of storage battery boxes 202, the storage battery units 101 are connected with each other in series and then electrically connected with the distribution box 204 that supplies power to the motor 205 of the vehicle; in a case that the storage battery units 101 are out of power, the storage battery units 101 are pulled out and then put into a charging cabinet 301 to be connected with the charging cabinet 301 through the socket 107 so as to be charged, simultaneously, new storage battery units 101 may be replaced into the storage battery boxes 202. The storage batteries are replaced in unit of group, so that no matter how many groups of storage batteries are out of power, they all may be replaced. According to the invention, the energy of the electric vehicle 201 may be supplemented whenever and wherever. The storage battery boxes 202 in the invention have rational layout, low and stable center of gravity, safe and firm structure, and fast and simple replacement of batteries. The portable storage batteries, which are put into the charging cabinet 301, are charged at the power off-peak period, to get out of the peak hours of power consumption, in order to achieve the effect of peak and off-peak regulation.

The storage battery boxes 202 may also be designed to be independently powered by a plurality of groups of power supplies. When one group of the groups of power supplies is out of power, this group will skip to the next group of power supplies automatically for continuous operation.

By the method for using the portable storage battery in the invention, the storage batteries may be connected into or separated from the storage battery boxes 202 quickly, the charging mode for the electric vehicle 201 is changed into a battery-replacing mode, the user is unlikely to worry about looking for a charging station at any moment, and both time and travel of the user are not delayed. The replaced storage battery units 101 are put into the charging cabinet 301 to be charged at the power off-peak period, to get out of the peak hours of power consumption, in order to achieve the effect of peak and off-peak regulation, thus to effectively and rationally utilize resources. By the method for using the portable storage battery in the invention, the storage batteries may be used and replaced independently and may also be used in groups, therefore the flexibility of the replacement of storage batteries in the electric vehicle 201 is enhanced, and the maintenance also becomes easy.

As the portable storage batteries in the invention are not mounted in the electric vehicle 201 fixedly, when the electric vehicle 201 is purchased, the storage battery units 101 may be rented, this will reduce the cost greatly, and the service life and the maintenance and the like of the storage batteries are not concerned. That is, each time when the storage battery units 101 that are out of power are replaced, personnel in the leasing companies insert the plug 107 of the storage battery units 101 into the charging cabinet 301 for charging. As each one of the storage battery units 101 has a safe voltage of 36V, the storage battery units 101 may be replaced whenever and wherever.

According to the invention, many charge and battery-replacing modes may be adopted, all battery-replacing stations may operate the leasing business, and the leasing companies are responsible for centralized charging and uniform distribution. The charging, maintenance and energy updating of storage batteries are performed by the leasing companies. The electric vehicle user replaces batteries according to actual demands. At that time, battery-replacing stations will be ten times more than the existing gas stations. Furthermore, the investment of the battery-replacing stations is less, so that the use of electric vehicles becomes economic, practical, easy, energy saved and emission reduced, and energy resources are used rationally.

The electric vehicle 201 is provided with a charging socket 203. When there is a charging post in the parking space, the electric vehicle 201 may be charged by wire using traditional methods, it may also be charged by wire in the parking space after the user goes home. For a parking place with a charging cabinet 301 only, the storage battery units 101 may be inserted into the charging cabinet 301 to be charged at night and then put into the storage battery boxes 202 for continuous use in the morning, it is convenient and fast.

The above embodiments are preferred implementation solutions of the invention, and the invention may also have other implementation ways in addition to these embodiments. Any obvious replacement without departing from the concept of the invention should be included within the protection scope of the invention.

What is claimed is:

1. A portable storage battery for electric vehicles, comprising storage battery units that include a storage battery casing, wherein a storage battery cell is arranged in the storage battery casing and a socket is arranged at the end of the storage battery casing.

2. The portable storage battery for electric vehicles according to claim 1, wherein the storage battery units have a voltage of 36V.

3. The portable storage battery for electric vehicles according to claim 1, wherein the storage battery cell consists of a plurality of cylindrical storage batteries connected in series and/or in parallel.

4. The portable storage battery for electric vehicles according to claim 1, wherein a storage battery cover is arranged above the storage battery casing and articulated with the storage battery casing.

5. The portable storage battery for electric vehicles according to claim 1, wherein the storage battery casing is provided with a handle.

6. The portable storage battery for electric vehicles according to claim 1, wherein the storage battery casing is provided with a protective valve for protecting the socket.

7. The portable storage battery for electric vehicles according to claim 1, wherein the socket is also provided with a power plug.

8. The portable storage battery for electric vehicles according to claim 7, wherein the power plug is provided with an air inlet and an air outlet, which are communicated with the interior of the storage battery casing, respectively.

9. The portable storage battery for electric vehicles according to claim 7, wherein the power plug is provided with an information transfer joint.

10. The portable storage battery for electric vehicles according to claim 7, wherein the power plug is sleeved with a water-proof sealing ring.

11. A method for using the portable storage battery for electric vehicles, comprising steps as follows: putting the required number of storage battery units in storage battery boxes in electric vehicles and connecting the storage battery units in series for use; in a case that the storage battery units are out of power, the storage battery units are pulled out, respectively, and then put into a charging cabinet to be connected with the charging cabinet through the socket so as to be charged.

12. The method for using the portable storage battery for electric vehicles according to claim 11, wherein the storage battery units that are put into the charging cabinet are charged at the power off-peak period.
